(19) United States
(12) Patent Application Publication
(10) Pub. No.: US 2018/0088728 A1
(43) Pub. Date: Mar. 29, 2018

(54) INTEGRATED FORCE-SENSITIVE TOUCH SCREEN

(71) Applicant: Apple Inc., Cupertino, CA (US)

(72) Inventors: Joshua G. WURZEL, Campbell, CA (US); Abbas JAMSHIDI-ROUDBARI, Sunnyvale, CA (US); Ting-Kuo CHANG, Hsinchu City (TW)

(21) Appl. No.: 15/704,625

(22) Filed: Sep. 14, 2017

Related U.S. Application Data
(60) Provisional application No. 62/399,141, filed on Sep. 23, 2016.

(51) Int. Cl. G06F 3/041; G06F 3/044

(52) U.S. Cl. CPC G06F 3/0416; G06F 2203/04105; G06F 2203/04108; G06F 3/044

(57) ABSTRACT

This relates to a force-sensitive touch screen including a metallization layer for force sensing. In some examples, the force-sensing metallization layer can be deposited between a color filter layer and a thin film transistor (TFT) layer (including an array of TFTs) of the touch screen. In some examples, the metallization layer can be electrically coupled to a patterned conductive layer. Together, a force-sensing metallization trace of the metallization layer and a patterned conductor of the patterned conductive layer can act as a force sensor. Additionally or alternatively, the device can include a force-sensing metallization layer and a conductive layer (patterned or not) located beneath the TFT layer (i.e., rather than between a color filter layer and the TFT layer).

### CROSS REFERENCE TO RELATED APPLICATIONS

This application claims the benefit under 35 USC 119(e) of U.S. Patent Application No. 62/399,141, filed Sep. 23, 2016, the contents of which are incorporated herein by reference in their entirety for all purposes.

### FIELD OF THE DISCLOSURE

This relates to a force-sensitive touch screen and, more particularly, to a force-sensitive touch screen including metallization traces for force sensing.

### BACKGROUND OF THE DISCLOSURE

Many types of input devices are presently available for performing operations in a computing system, such as buttons or keys, mice, trackballs, joysticks, touch electrode panels, touch screens and the like. Touch screens, in particular, are becoming increasingly popular because of their ease and versatility of operation as well as their declining price. Touch screens can include a touch electrode panel, which can be a clear panel with a touch-sensitive surface, and a display device such as a liquid crystal display (LCD) that can be positioned partially or fully behind the panel so that the touch-sensitive surface can cover at least a portion of the viewable area of the display device. Touch screens can allow a user to perform various functions by touching the touch electrode panel using a finger, stylus or other object at a location often dictated by a user interface (UI) being displayed by the display device. In general, touch screens can recognize a touch and the position of the touch on the touch electrode panel, and the computing system can then interpret the touch in accordance with the display appearing at the time of the touch, and thereafter can perform one or more actions based on the touch. In the case of some touch sensing systems, a physical touch on the display is not needed to detect a touch. For example, in some capacitive-type touch sensing systems, fringing electrical fields used to detect touch can extend beyond the surface of the display, and objects approaching near the surface may be detected near the surface without actually touching the surface.

In some examples, touch panels/touch screens may include force sensing capabilities—that is, they may be able to detect an amount of force with which an object is touching the touch panels/touch screens. These forces can constitute force inputs to electronic devices for performing various functions, for example. Including force sensing capabilities, however, can increase the size (thickness) of a device including a force-sensitive touch screen.

### SUMMARY OF THE DISCLOSURE

This relates to device force-sensitive touch screen including a metallization layer for force sensing. In some examples, the force-sensing metallization layer can be deposited between a color filter layer and a thin film transistor (TFT) layer (including an array of TFTs) of the touch screen. In some examples, the metallization layer can be electrically coupled to a patterned conductive layer. During a display phase, the force-sensing metallization traces of the force-sensing metallization layer and the patterned conductors of the patterned conductive layer can receive a common voltage, for example, to properly display and image on the touch screen. During a touch phase, for example, the force-sensing metallization traces and the patterned conductors can act as touch nodes to sense a touch by an object on the surface of the touch screen. During a force phase, for example, a first signal can be applied to the patterned conductors of the patterned conductive layer and one or more second signals indicative of an applied force at the touch screen be sensed from one or more force-sensing metallization traces.

Additionally or alternatively, the device can include a force-sensing metallization layer and a conductive layer (patterned or not) located beneath the TFT layer (i.e., rather than between a color filter layer and the TFT layer). The force-sensing metallization layer can be electrically coupled to the conductive layer, for example. In some examples, the touch screen can concurrently display an image and sense a force using force-sensing metallization traces of the force-sensing metallization layer and the conductive layer during a display/force phase. A first signal can be applied to the conductive layer and one or more second signals indicative of an applied force at the touch screen can be sensed from one or more force-sensing metallization traces. During a touch phase, the touch screen can sense a touch at its surface with one or more touch nodes.

### BRIEF DESCRIPTION OF THE DRAWINGS

FIGS. 1A-1C illustrate exemplary devices that can include a force-sensitive touch screen according to examples of the disclosure.

FIG. 2 illustrates a three-dimensional illustration of an exploded view (expanded in the z-direction) of an exemplary stack-up showing some of the elements within an exemplary integrated touch screen according to examples of the disclosure.

FIG. 3A illustrates a top view of an exemplary touch screen configured for sensing an applied force according to examples of the disclosure.

FIGS. 3B-3C illustrate cross-sections of an exemplary touch screen according to examples of the disclosure.

FIG. 3D illustrates an exemplary control circuit for controlling force sensing, touch sensing, and display operations at a touch screen according to examples of the disclosure.

FIG. 3E illustrates an exemplary timing diagram for updating a displayed image in a display phase, sensing a touch during a touch phase, and sensing a force during a force phase according to examples of the disclosure.

FIG. 4A illustrates a top view of an exemplary touch screen with a common conductive layer configured for sensing an applied force according to examples of the disclosure.

FIG. 4B illustrates a top view of an exemplary touch screen with a patterned conductive layer configured for sensing an applied force according to examples of the disclosure.

FIGS. 4C-4D illustrate cross-sections of an exemplary touch screen according to examples of the disclosure.

FIG. 4E illustrates an exemplary timing diagram for operating a touch screen according to examples of the disclosure.

FIG. 5A illustrates a cross section of an exemplary touch screen according to examples of the disclosure.

FIG. 5B illustrates an exemplary timing diagram for operating a touch screen according to examples of the disclosure.

FIG. 6 illustrates an exemplary process for sensing force at a touch screen according to example of the disclosure.

FIG. 7 illustrates exemplary computing system capable of implementing force sensing according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates to device force-sensitive touch screen including a metallization layer for force sensing. In some examples, the force-sensing metallization layer can be deposited between a color filter layer and a thin film transistor (TFT) layer (including an array of TFTs) of the touch screen. In some examples, the metallization layer can be electrically coupled to a patterned conductive layer. During a display phase, the force-sensing metallization traces of the force-sensing metallization layer and the patterned conductors of the patterned conductive layer can receive a common voltage, for example, to properly display and image on the touch screen. During a touch phase, for example, the force-sensing metallization traces and the patterned conductors can act as touch nodes to sense a touch by an object on the surface of the touch screen. During a force phase, for example, a first signal can be applied to the patterned conductors of the patterned conductive layer and one or more second signals indicative of an applied force at the touch screen be sensed from one or more force-sensing metallization traces.

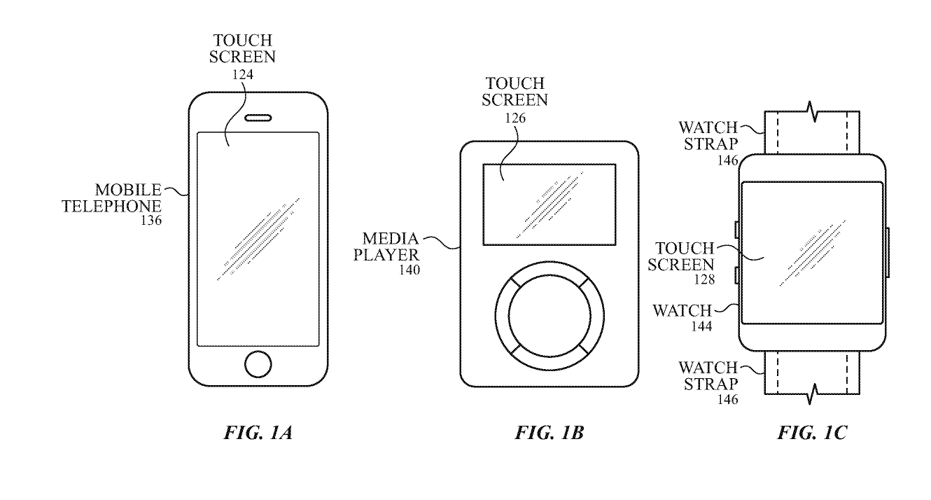

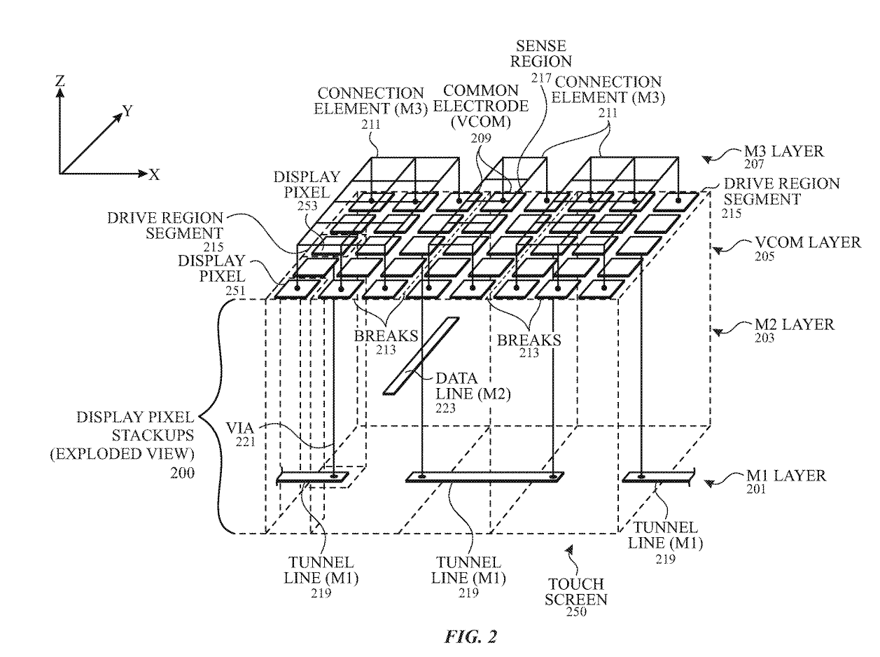

Additionally or alternatively, the device can include a force-sensing metallization layer and a conductive layer (patterned or not) located beneath the TFT layer (i.e., rather than between a color filter layer and the TFT layer). The force-sensing metallization layer can be electrically coupled to the conductive layer, for example. In some examples, the touch screen can concurrently display an image and sense a force using force-sensing metallization traces of the force-sensing metallization layer and the conductive layer during a display/force phase. A first signal can be applied to the conductive layer and one or more second signals indicative of an applied force at the touch screen can be sensed from one or more force-sensing metallization traces. During a touch phase, the touch screen can sense a touch at its surface with one or more touch nodes. FIGS. 1A-1C illustrate exemplary devices that can include a force-sensitive touch screen according to examples of the disclosure. FIG. 1A illustrates an example mobile telephone 136 that includes a force-sensitive touch screen 124. FIG. 1B illustrates an example digital media player 140 that includes a force-sensitive touch screen 126. FIG. 1C illustrates an example watch 144 that includes a force-sensitive touch screen 128. It is understood that the above touch screens can be implemented in other devices as well, such as tablet computers, laptop computers, desktop computers, wearable devices or other portable or non-portable computing devices. Furthermore, although the examples of the disclosure are described primarily in the context of a touch screen, it is to be understood that the examples of the disclosure can similarly be implemented in a touch-sensitive surface without display functionality (e.g., using a touch sensor panel).

In some examples, touch screens 124, 126 and 128 can be based on self-capacitance. A self-capacitance based touch system can include a matrix of small, individual plates of conductive material that can be referred to as touch node electrodes. For example, a touch screen can include a plurality of pixelated touch electrodes, each touch electrode identifying or representing a unique location on the touch screen at which touch or proximity (i.e., a touch or proximity event) is to be sensed, and each touch electrode being electrically isolated from the other touch node electrodes in the touch screen. Such a touch screen can be referred to as a pixelated self-capacitance touch screen, though it is understood that in some examples, the touch node electrodes on the touch screen can be used to perform scans other than self-capacitance scans on the touch screen (e.g., mutual capacitance scans). During operation, a touch node electrode can be stimulated with an AC waveform, and the self-capacitance to ground of the touch node electrode can be measured. As an object approaches the touch node electrode, the self-capacitance to ground of the touch node electrode can change. This change in the self-capacitance of the touch node electrode can be detected and measured by the touch sensing system to determine the positions of multiple objects when they touch, or come in proximity to, the touch screen. In some examples, the electrodes of a self-capacitance based touch system can be formed from rows and columns of conductive material, and changes in the self-capacitance to ground of the rows and columns can be detected, similar to above. In some examples, a touch screen can be multi-touch, single touch, projection scan, full-imaging multi-touch, capacitive touch, etc.

In some examples, touch screens 124, 126 and 128 can be based on mutual capacitance. A mutual capacitance based touch system can include drive and sense lines that may cross over each other on different layers, or may be adjacent to each other on the same layer. The crossing or adjacent locations can be referred to as touch nodes. During operation, the drive line can be stimulated with an AC waveform and the mutual capacitance of the touch node can be measured. As an object approaches the touch node, the mutual capacitance of the touch node can change. This change in the mutual capacitance of the touch node can be detected and measured by the touch sensing system to determine the positions of multiple objects when they touch, or come in proximity to, the touch screen.

In some examples, the touch screen of the disclosure can include force sensing capability in addition to the touch sensing capability discussed above. In the context of this disclosure, touch sensing can refer to the touch screen's ability to determine the existence and/or location of an object touching the touch screen, and force sensing can refer to the touch screen's ability to determine a “depth” of the touch on the touch screen (e.g., the amount of force with which the object is touching the touch screen). In some examples, the touch screen can also determine a location of the force on the touch screen.

FIG. 2 illustrates a three-dimensional illustration of an exploded view (expanded in the z-direction) of an exemplary stack-up 200 showing some of the elements within an exemplary integrated touch screen 250 according to examples of the disclosure. Stack-up 200 can include a configuration of conductive lines that can be used to group common electrodes, such as common electrodes 209, into drive region segments and sense regions, and to link drive region segments to form drive lines. Some examples can include other regions, such as a grounding region between drive lines and/or between drive lines and sense lines.

Stack-up 200 can include elements in a first metal (M1) layer 201, a second metal (M2) layer 203, a common electrode (Vcom) layer 205, and a third metal (M3) layer 207. It should be noted that although stack-up 200 is described as including display pixels, in some examples, one or more components of the display pixels can be used to perform other functions, such as touch sensing functions. Each display pixel can include a common electrode 209 that is formed in Vcom layer 205. M3 layer 207 can include connection element 211 that can electrically connect together common electrodes 209. Although a plurality of connections between the M3 layer 207 and the common electrodes 209 are shown as coupling a subset of the common electrodes to the M3 layer, in some examples, a different number of common electrodes or all of the common electrodes can be coupled to the M3 layer. In some display pixels, breaks 213 can be included in connection element 211 to separate different groups of common electrodes 209 to form drive region segments 215 and a sense region 217. Breaks 213 can include breaks in the x-direction that can separate drive region segments 215 from sense region 217, and breaks in the y-direction that can separate one drive region segment 215 from another drive region segment. M1 layer 201 can include tunnel lines 219 that can electrically connect together drive region segments 215 through connections, such as conductive vias 221, which can electrically connect tunnel line 219 to the grouped common electrodes in drive region segment display pixels. Tunnel line 219 can run through the display pixels in sense region 217 with no connections to the grouped common electrodes in the sense region, e.g., no vias 221 in the sense region. M2 layer 203 can include data lines 223. Only one data line 223 is shown for the sake of clarity; however, a touch screen can include multiple data lines running through each vertical row of display pixels, for example, one data line for each red, green, blue (RGB) color sub-pixel in each display pixel in a vertical row of an RGB display integrated touch screen.

Structures such as connection elements 211, tunnel lines 219, and conductive vias 221 can operate as a touch sensing circuitry of a touch sensing system to detect touch during a touch sensing phase of the touch screen. Structures such as data lines 223, along with other display pixel stack-up elements such as transistors, pixel electrodes, common voltage lines, data lines, etc. (not shown), can operate as display circuitry of a display system to display an image on the touch screen during a display phase. Structures such as common electrodes 209 can operate as multifunction circuit elements that can operate as part of both the touch sensing system and the display system.

For example, during a touch sensing phase, stimulation signals can be transmitted through a row of drive region segments 215 connected by tunnel lines 219 and conductive vias 221 to form electric fields between the stimulated drive region segments and sense region 217 to create touch nodes. In this way, the row of connected together drive region segments 215 can operate as a drive line, and sense region 217 can operate as a sense line for a mutual capacitance touch screen. When an object such as a finger approaches or touches a touch node, the object can affect the electric fields extending between the drive region segments 215 and the sense region 217, thereby reducing the amount of charge capacitively coupled to the sense region. This reduction in charge can be sensed by a sense channel of a touch sensing controller connected to the touch screen.

Although touch screen 250 illustrated in FIG. 2 can re-use components to display an image and sense a touch, its configuration does not allow for sensing an applied force. In some examples, additional components and/or circuitry can be added to touch screen 250 to sense force. These added components can add thickness and/or weight to the touch screen 250. Therefore, in some examples, it can be advantageous to leverage existing components to sense an applied force.

Although FIG. 2 illustrates a row and column configuration of drive regions and sense regions forming drive lines and sense lines for row-column mutual capacitance touch sensing, the row and column configuration can be used for self-capacitance touch sensing, in which the drive and sense regions form lines which can be stimulated and sense to measure self-capacitance. For a pixelated self-capacitance configuration, rather than forming drive and sense lines, drive/sense regions can be formed touch nodes.

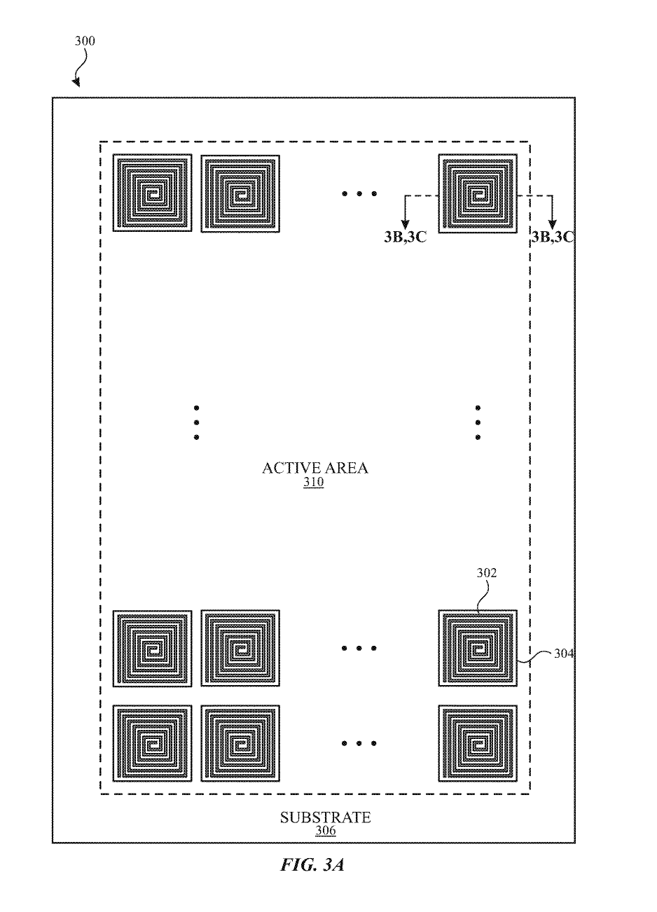

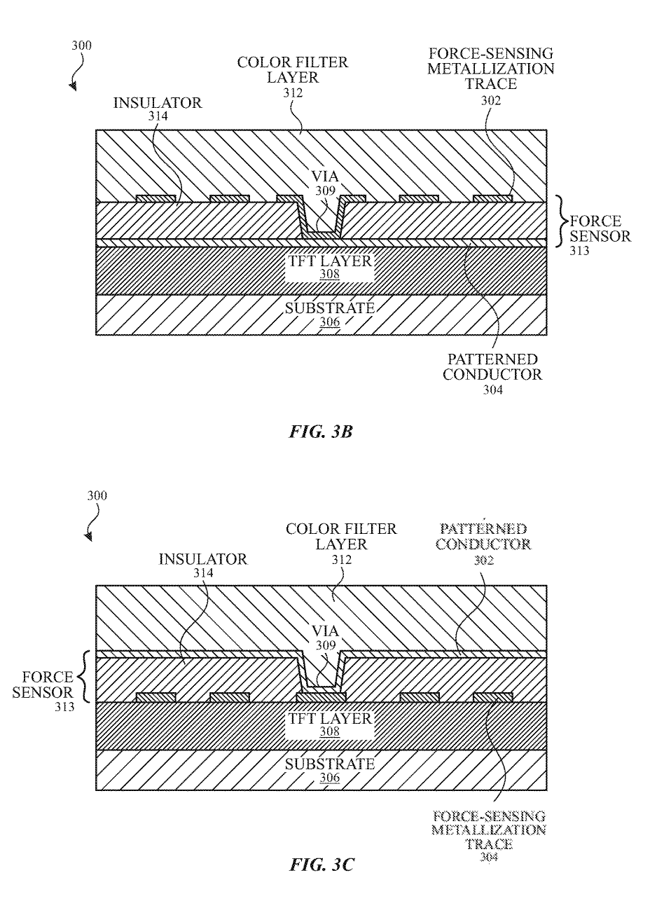

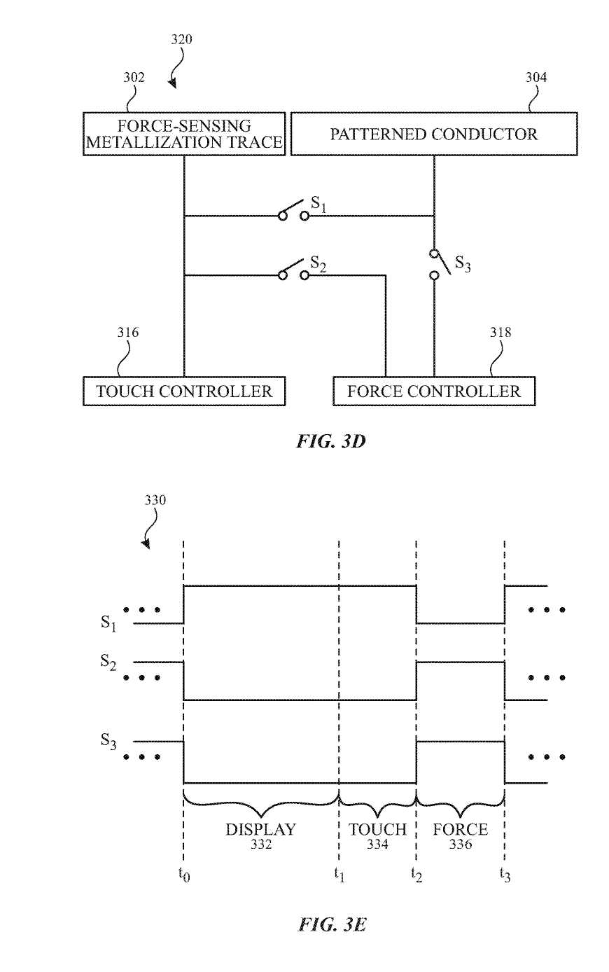

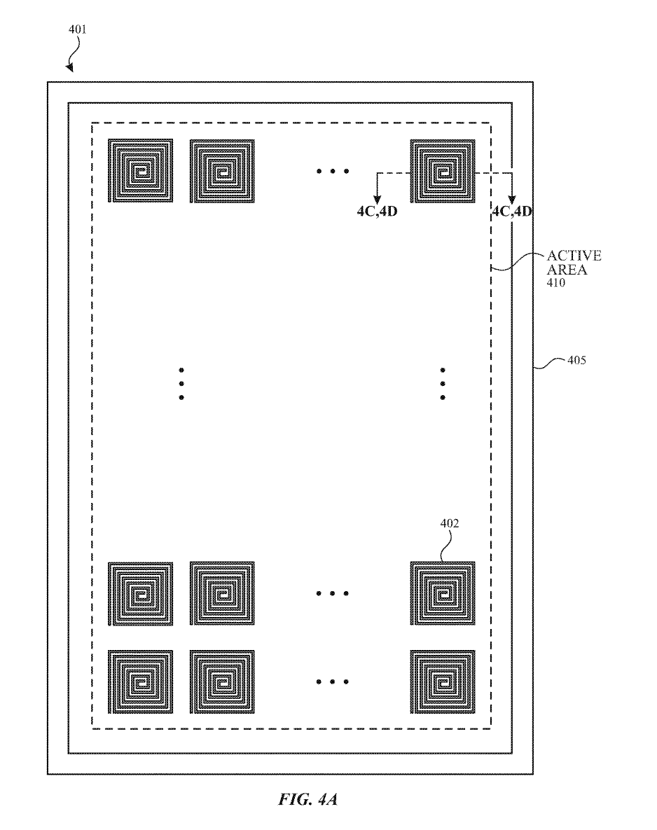

FIG. 3A illustrates a top view of an exemplary touch screen 300 configured for sensing an applied force according to examples of the disclosure. Touch screen 300 can include an active area 310 in which a touch and/or an applied force can be sensed. In some examples, the active area 310 can include a force-sensing metallization layer including a plurality of force-sensing metallization traces 302 and a patterned conductive layer including a plurality of patterned conductors 304 situated above substrate 306. Although touch screen 300 is described as including force-sensing metallization traces 302, it should be appreciated that, in some examples, the force-sensing traces can perform additional functions in the stack-up outside of sensing a force (e.g., displaying an image, sensing a touch, etc.).

In some examples, force-sensing metallization traces 302 can be formed in the M3 layer (e.g., M3 layer 207). The force-sensing metallization traces 302 can be formed of a conductive material (e.g., metal) arranged in a spiral shape, for example. By shaping force-sensing metallization traces 302 in a spiral shape, a relatively long conductive trace can be provided in a small surface area of touch screen 300. Although FIG. 3A illustrates spiral shaped traces, in some examples, other shapes or patterns are possible. When a force is applied to touch screen 300 (e.g., from a user's finger), one or more force-sensing metallization traces 302 can deform, changing an electrical resistance of the one or more force-sensing metallization traces. The resistance of the force-sensing metallization traces 302 can be sensed to measure an applied force, for example.

FIGS. 3B-3C illustrate cross-sections of an exemplary touch screen 300 according to examples of the disclosure. Touch screen 300 can include force-sensing metallization trace 302 in a force-sensing metallization layer, a patterned conductor 304 in a patterned conductive layer, substrate 306, TFT layer 308, color filter layer 312, and insulator 314, for example. In some examples, touch screen 300 can include additional layers and/or components (e.g., liquid crystal layer, polarizer(s), etc.). Force-sensing metallization trace 302 and the patterned conductor 304 can be electrically coupled by via 309, for example. Force-sensing metallization trace 302, insulator 314, and patterned conductor 304 can form a force sensor 313, for example. Force sensor 313 can be an in-cell force sensor because it is situated between color filter layer 312 and TFT layer 308.

As shown in FIG. 3B, the patterned conductor 304 (and the patterned conductive layer) can be situated on top of TFT layer 308, for example. In some examples, insulator 314 can be situated directly on top of the patterned conductive layer. In some examples, insulator 314 can insulate the patterned conductor 304 from the force-sensing metallization trace 302, which can be situated on top of the insulator 314. In this configuration, the force-sensing metallization trace 302 can potentially be visible to a user of touch screen 300 as an optical artifact, as intermediate layers between the force-sensing metallization trace 302 and the color filter layer 312 may be deposited on the uneven surface of the force sensor (e.g., because the force sensing metallization layer can be uneven as illustrated in FIG. 3B). In some examples, an alternative arrangement of components can be desirable to improve the quality of an image displayed on touch screen 300 (e.g., by reducing optical artifacts).

As shown in FIG. 3C, the force-sensing metallization trace 302 can be situated on top of TFT layer 308, for example. In some examples, insulator 314 can be situated directly on top of force-sensing metallization trace 302. In some examples, insulator 314 can insulate the force-sensing metallization trace 302 from patterned conductor 304, which can be situated on top of the insulator 314. Patterned conductor 304 can be deposited to form a smooth surface on which intermediate layers between the patterned conductive layer and the color filter layer 312 can be formed, for example. In some examples, the arrangement shown in FIG. 3C can improve the quality of a displayed image over the arrangement shown in FIG. 3B (e.g., by reducing optical artifacts).

FIG. 3D illustrates an exemplary control circuit 320 for controlling force sensing, touch sensing, and display operations at a touch screen 300 according to examples of the disclosure. As shown in FIG. 3A, touch screen 300 can include a plurality of patterned conductors 304 in the patterned conductive layer and a plurality of force-sensing metallization traces 302 in the force sensing metallization layer. For ease of description, operation of one force sensing metallization trace 302 and patterned conductor 304 is illustrated in FIG. 3D. In some examples, control circuit 320 can be coupled to force-sensing metallization trace 302 and patterned conductor 304. Control circuit 320 can further include a plurality of switches (S1, S2, and S3) to appropriately couple the force-sensing metallization trace 302 and the patterned conductor 304 to a touch controller 316 and/or a force controller 318, for example. In some examples, S1, S2, and S3 can be implemented with a plurality of transistors such as MOSFETs or any other suitable transistor or other type of switch. The operation of control circuit 320 will be described with reference to FIG. 3E.

FIG. 3E illustrates an exemplary timing diagram 330 for updating a displayed image in a display phase 332, sensing a touch during a touch phase 334, and sensing a force during a force phase 336 according to examples of the disclosure. Timing diagram 330 can include controls for switches S1, S2 and S3 included in control circuitry 320. As shown in FIG. 3E, when a switch's control signal is “high,” the switch can be closed, for example. Likewise, when a switch's control signal is “low,” the switch can be open. It should be understood that the association of switch state and control signals is exemplary and can be reversed in some examples.

Touch screen 300 can be in display phase 332 from t0 to t1, for example. During the display phase 332, S1 can be closed, coupling force-sensing metallization trace 302 and patterned conductor 304 together. S2 and S3 can be open, decoupling the force-sensing metallization trace 302 and patterned conductor 304 from force controller 318. Force-sensing metallization trace 302 and patterned conductor 304 can act as a common electrode to display an image on the touch screen 300. Touch controller 316 (and/or associated display controller) can apply a common voltage to the common electrode (e.g., force-sensing metallization trace 302 and patterned conductor 304 together) during display phase 332.

Touch screen 300 can be in touch phase 334 from t1 to t2, for example. During touch phase 334, S1 can be closed, coupling force-sensing metallization trace 302 and patterned conductor 304 together. Force-sensing metallization trace 302 and patterned conductor 304 can act as a common electrode and touch node for touch sensing operations of touch screen 300. Touch controller 316 can apply a stimulation signal to the touch nodes and sense a self-capacitance of the stimulated sensors, for example. In some examples, results of the touch sensing operations can be used to select a subset of force sensors to be sampled during a force phase. Sampling a subset of the force sensors can reduce power consumption for force sensing and/or provide force scan time to allow a greater number of samples to be taken (i.e., increased integration time), thus improving the reliability of the force sensing. S2 and S3 can be open, decoupling the force-sensing metallization trace 302 and patterned conductor 304 from the force controller 318.

Touch screen 300 can be in force phase 336 from t2 to t3, for example. During force phase 336, S1 can be open, decoupling the force-sensing metallization trace 302 and patterned conductor 304 from one another. S2 and S3 can be closed, coupling force-sensing metallization trace 302 and the patterned conductor 304 to force controller 318. In some examples, force controller 318 can apply a first signal to the patterned conductor 304 and sense a second signal from the force-sensing metallization trace 302 indicative of an applied force. For example, a current can be applied through the patterned conductor 304 and force-sensing metallization trace 302 and a voltage of the force-sensing metallization trace 302 can be measured to determine a magnitude of applied force at that force sensor.

In some examples, touch screen can repeat the three phases in the order shown in the timing diagram 330 (e.g., once per display frame). In some examples, the various phases can be performed more than once during a display frame. In some examples, one or more of the phases can be divided into sub-phases which can be performed during a display phase. For example, the touch sensing operation can be divided into a first number of sub-phases, the force sensing operation can be divided into a second number of sub-phases, and/or the display operation can be divided into a fourth number of sub-phases. The ordering and timing of the sub-frames can follow the order illustrated in FIG. 3E or follow a different order. In some examples, the one or more phases illustrated in FIG. 3E can be performed in a different order.

Although FIGS. 3D and 3E illustrate operation for one force-sensing metallization trace and one patterned conductor, it should be understood that similar control can be provided for the plurality of force-sensing metallization traces and patterned conductors. In some examples, a plurality of control circuits 320 can be provided to control each force-sensing metallization trace 302 and respective patterned conductor. In some examples, multiple force-sensing metallization traces 302 and patterned conductors can share control circuitry (e.g., via multiplexing circuitry).

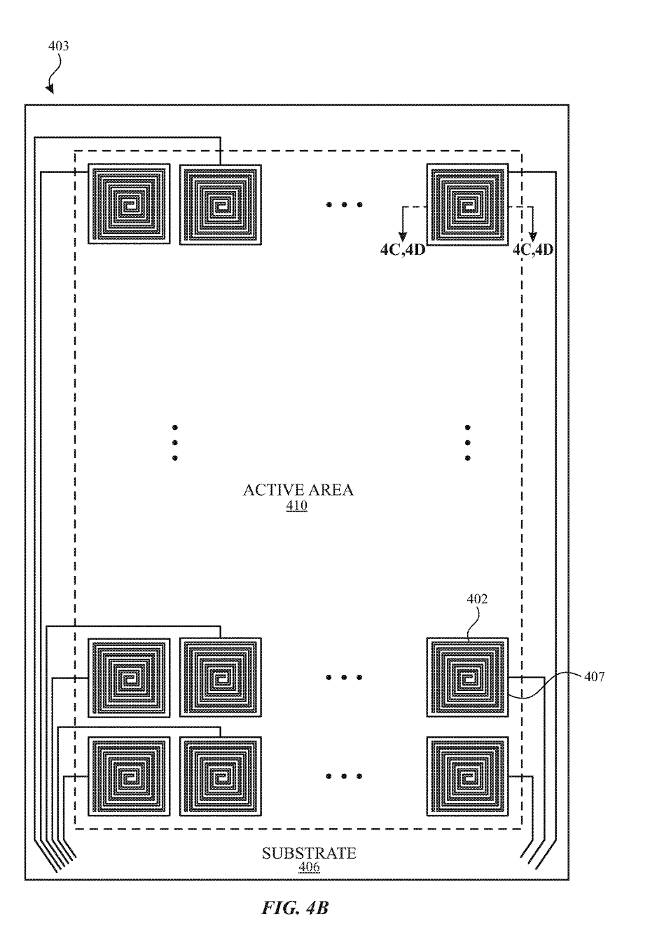

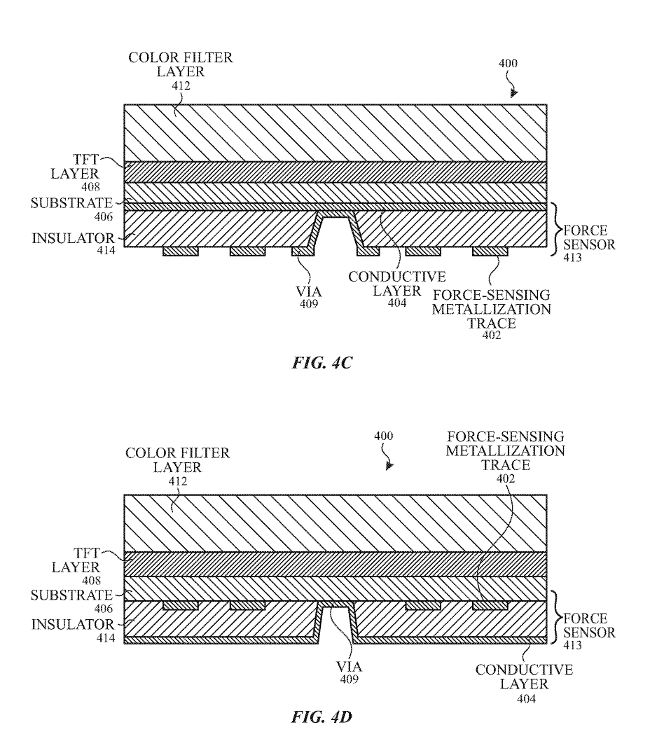

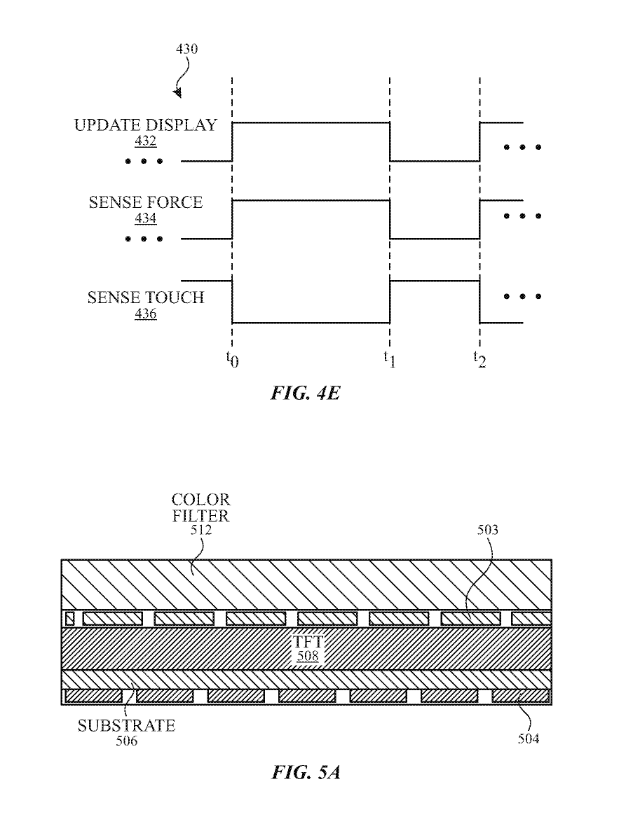

FIG. 4A illustrates a top view of an exemplary touch screen 401 with a common conductive layer 405 configured for sensing an applied force according to examples of the disclosure. Touch screen 401 can include an active area 410 in which a touch and/or an applied force can be sensed. In some examples, the active area 410 can include a plurality of force-sensing metallization traces 402. Touch screen 401 can further include a common conductive layer 405. Unlike the patterned conductors 304 in a patterned conductive layer of FIGS. 3A-3C, a common conductive layer can be formed as a continuous layer. A common conductive layer 405 can allow for simpler routing, improved yield and reduced cost, compared to a touch screen with a patterned conductive layer. To sense force, a first signal can be applied to the common conductive layer 405 and second signals indicative of an applied force can be sensed at the respective force-sensing metallization traces 402. For example, current can be applied at common conductive layer 405 and the voltage at each force-sensing metallization trace 402 can be sensed to determine a magnitude of force (and corresponding location) at each force sensor in touch screen 401. Although touch screen 401 is described as including force-sensing metallization traces 402, it should be appreciated that, in some examples, the force-sensing metallization traces can perform additional functions outside of sensing a force (e.g., displaying an image, sensing a touch, etc.).

FIG. 4B illustrates a top view of an exemplary touch screen 403 with a patterned conductive layer configured for sensing an applied force according to examples of the disclosure. Touch screen 403 can include an active area 410 in which a touch and/or an applied force can be sensed. In some examples, the active area 410 can include a plurality of force-sensing metallization traces 402 and patterned conductive layer including a plurality of patterned conductors 407. Touch screen 403 can further include a substrate 406. In some examples, providing a patterned conductive layer can offer an improved signal-to-noise ratio (SNR), compared to a force-sensitive touch screen with a common conductive layer. To sense force, a first signal can be applied to each patterned conductor 407 and second signals indicative of an applied force can be sensed at the respective force-sensing metallization traces 402. For example, current can be applied at the patterned conductor 407 and the voltage at each force-sensing metallization trace 402 can be sensed to determine a magnitude of force (and a location) at each force sensor of touch screen 403. Although touch screen 403 with a patterned conductive layer can have an improved SNR over a touch screen with a common conductive layer (e.g., touch screen 401 with common conductive layer 405), the routing and manufacture of touch screen 403 can be more complicated. For example, a plurality of routing traces 411 can be required to provide a current to each patterned conductor 407 when sensing force. Although touch screen 403 is described as including force-sensing metallization traces 402, it should be appreciated that, in some examples, the force-sensing metallization traces can perform additional functions outside of sensing a force (e.g., displaying an image, sensing a touch, etc.).

In some examples, force-sensing metallization traces 402 included in touch screen 401 or touch screen 403 can be deposited on the M3 layer (e.g., M3 layer 207). The force-sensing metallization traces 402 can be formed of a conductive material arranged in a spiral shape, for example. By shaping force-sensing metallization traces 402 in a spiral shape, a relatively long conductive trace can be provided in a small surface area of touch screen 401 or touch screen 403. When a force is applied to touch screen 401 or touch screen 403 (e.g., from a user's finger), one or more force-sensing metallization traces 402 can deform, changing an electrical resistance of the one or more force sensors. In some examples, shapes other than spirals are possible for the force-sensing metallization traces.

FIGS. 4C-4D illustrate cross-sections of an exemplary touch screen 400 according to examples of the disclosure. In some examples, touch screen 400 can include force-sensing metallization trace 402, conductive layer 404, substrate 406, TFT layer 408, color filter layer 412, and insulator 414. Force-sensing metallization trace 402 can be an “on-cell” force sensor because it is not situated between color filter layer 412 and TFT layer 408 (or substrate 406). In some examples, the conductive layer 404 of touch screen 400 can be a common conductive layer (e.g., common conductive layer 405) or it can be a patterned conductive layer (e.g., patterned conductive layer 407). Force-sensing metallization trace 402 and conductive layer 404 can be electrically coupled by via 409, for example. In some examples, touch screen 400 further includes substrate 406 to support TFT layer 408.

As shown in FIG. 4C, the conductive layer 404 can be situated adjacent to substrate 406, for example. In some examples, insulator 414 can be situated directly adjacent to the conductive layer 404 on its other side to insulate conductive layer 404 from the force-sensing metallization trace 402, which can be situated on the other side of the insulator 414. In an absence of an additional layer or component on the exposed side of force-sensing metallization trace 402, the force sensor can corrode over time, for example. In some examples, an additional passivation layer (not shown) can be applied to the exposed side of force-sensing metallization trace 402 to prevent it from corroding.

In some examples, however, it can be desirable to position force-sensing metallization trace 402 within touch screen 400 so that it does not have an exposed side, thus preventing its corrosion without including an additional passivation layer or other component.

As shown in FIG. 4D, the force-sensing metallization trace 402 can be deposited on a side of substrate 406 (side opposite TFT layer 408), for example. In some examples, insulator 414 can be formed over force-sensing metallization trace 402 (substrate 406) to insulate the force-sensing metallization trace 402 from conductive layer 404. Insulation layer can also protect force-sensing metallization trace 402 from exposure to air or water. In some examples, this configuration can offer improved touch sensor reliability over a force-sensitive touch screen where the force-sensing metallization trace 402 has an exposed side. For example, positioning force-sensing metallization trace 402 as illustrated in FIG. 4D can prevent corrosion of force-sensing metallization trace 402 without an additional passivation layer, as described above with reference to FIG. 4C.

FIG. 4E illustrates an exemplary timing diagram 430 for operating touch screen 400 according to examples of the disclosure. Timing diagram 430 can include controls (e.g., synchronization signals) to indicate when display operations, touch sensing operations and force sensing operations can occur. For example, a display control signal 432 can be active (e.g., logic high) during a display phase. A force control signal 434 can be active (e.g., logic high) during a force phase. A touch control signal 436 can be active (e.g., logic high) during a touch phase. As illustrated in FIG. 4E, for an on-cell implementation, display and force sensing operations can occur in a display/force phase.

During the display/force phase from t0 to t1, touch screen 400 can update a displayed image and sense force applied to touch screen 400, for example. Rather than sensing force during a dedicated force sensing phase at the expense of display time, display frequency, and/or touch frequency, touch screen 400 can concurrently update the display and sense force. In some examples, sampling force and updating the display can be synchronized to reduce noise in the force data due to display. For example, updating the display can include activating and deactivating a gate line, which can inject relatively high noise into force sensing. Force can be sensed with a frequency and timing such that the force sampling periods do not overlap with a transition of the gate line (e.g., when the gate line is turning activating or deactivating).

During a touch phase from t1 to t2, touch screen 400 can sense a touch, for example. In some examples, sensing touch can include sensing hover and other proximity events. Sensing touch can include measuring a self and/or mutual capacitance of one or more touch sensors included in touch screen 400, as described with reference to FIGS. 1A-1C, for example. In some examples, touch data can be used to select a subset of force sensors to be sampled during the display/force phase. Sampling a subset of the force sensors can reduce power consumption and/or allow a greater number of samples to be taken, thus improving the quality of the force data.

As discussed above with respect to FIG. 3E, the sequence of phases is merely representative and the various operations can be performed in a different order. Additionally, one or more of the various phases can be divided into sub-phases.

Although the touch screens described above with reference to FIGS. 1A-4E can sense force in addition to sensing touch, in some examples, thermal irregularities of the touch screen can impact user experience. For example, body heat of a user's finger can cause one part of the touch screen to be warmer than the rest of the touch screen, leading to a false positive force event. Other external heat sources, such as an open flame or a warm device in contact with the device including the touch screen, can cause the device to become warm and generate a false positive force event. In some examples, parts or components of an electronic device including a touch screen, such as a system on chip or camera, can become warm during operation and generate a false positive force event by becoming a source of thermal irregularity. Therefore, it can be advantageous to provide a touch screen that can reject thermal regularity to improve force sensing accuracy.

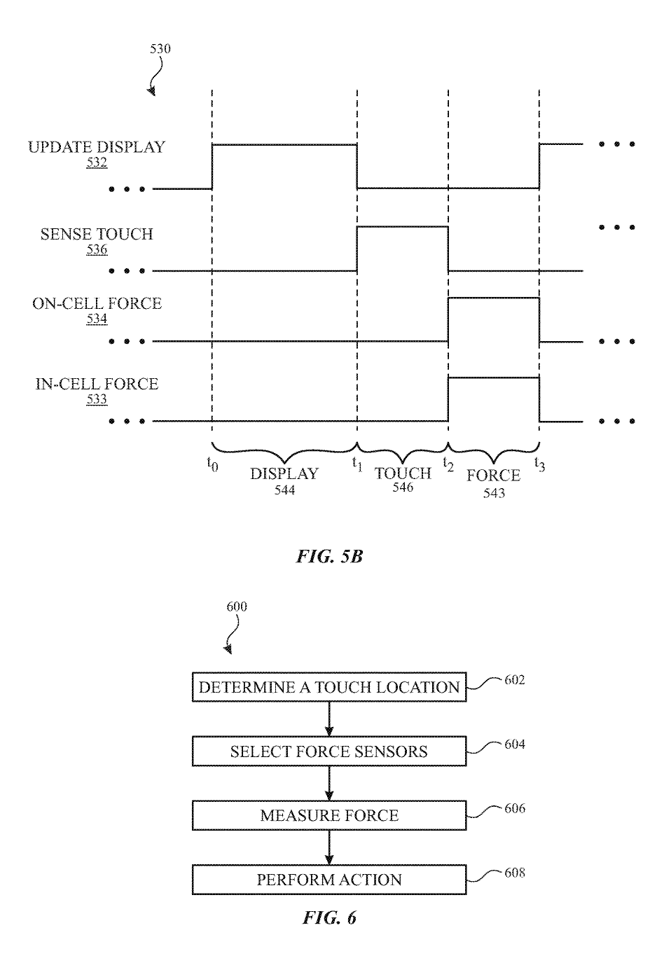

FIG. 5A illustrates a cross section of an exemplary touch screen 500 according to examples of the disclosure. In some examples, touch screen 500 can include in-cell force sensors 503 and on-cell force sensors 504 to provide two measurements of force. Although in-cell force sensors 503 and on-cell force sensors 504 are illustrates as being staggered with respect to each other, in some examples, in-cell force sensors and on-cell force sensors are disposed in in-cell and on-cell pairs with overlapping gaps. Touch screen 500 can further include substrate 506, TFT layer 508, and color filter layer 512, for example. In-cell force sensors can include a force-sensing metallization traces (e.g., force-sensing metallization trace 302), an insulator (e.g., insulator 314), and a patterned conductive layer including a plurality of patterned conductors (e.g., patterned conductors 304). On-cell force sensors can include a force-sensing metallization traces (e.g., force-sensing metallization trace 402), an insulator (e.g., insulator 414), and a conductive layer (e.g., conductive layer 404). In some examples, in-cell force sensor 503 can be configured as shown in FIG. 3B or FIG. 3C. In some examples, on-cell force sensor 504 can be configured as shown in FIG. 4C or FIG. 4D.

In some examples, force measurements from both the in-cell force sensors 503 and the on-cell force sensors 504 can be used to generate force sensing measurements compensated for thermal irregularities at touch screen 500. For example, a true force event can cause both force sensor 503 and force sensor 504 at a given location to indicate a force event, while heat transfer may cause a disparity in the amount of force measured at each of the force sensors. In some examples, a force controller can receive force measurements from in-cell force sensor 503 and on-cell force sensor 504. The force measurements can be transmitted to a processor, which can resolve, based on both sets of force measurements, which force data are caused by an applied force versus which force data are caused by thermal irregularity. In some examples, the processor can determine an amount of force by averaging the force measurement from the in-cell force sensor and the on-cell force sensor. In some examples, the processor can determine whether to report a force measurement when the in-cell measurement and on-cell measurement are within a threshold amount of one another. In some examples, when the in-cell measurement and on-cell measurement are different by more than the threshold amount, the measured force can be ignored, scaled or assigned a lower confidence.

In some examples, touch screen 300, 400 or 500 can further include a heat spreader (not shown) to further reduce the effects of thermal irregularities. The heat spreader can be made of a highly heat-conductive material, such as graphite or IGZO and can be positioned within the material stack-up along with other components, for example. In some examples, the heat spreader can be situated at the bottom of the stack-up such that it does not block the display.

FIG. 5B illustrates an exemplary timing diagram 530 for operating touch screen 500 according to examples of the disclosure. Timing diagram 530 can include controls (e.g., synchronization signals) to indicate when display operations, touch sensing operations and force sensing operations can occur. For example, a display control signal 532 can be active (e.g., logic high) during a display phase. An on-cell force control signal 534 can be active (e.g., logic high) and an in-cell force control signal 533 can be active (e.g., logic high) during a force phase. A touch control signal 536 can be active (e.g., logic high) during a touch phase. During a display phase 544 from t0 to t1, touch screen 500 can update the image displayed on the display as described above with reference to FIG. 3E. During a touch phase 546 from t1 to t2, touch screen 500 can sense touch as described above with reference to FIG. 3E. During force phase 543 from t2 to t3, touch screen 500 can sense force using an in-cell force sensor 503 and an on-cell force sensor 504. A difference in response between an in-cell force sensor 503 and an on-cell force sensor 504 at a same location on the touch screen 500 can be indicative of thermal irregularity, rather than a force event. When both the in-cell force sensor 503 and the on-cell force sensor 504 at the same location have a same response, the response can be indicative of an applied force. In some examples, a difference threshold can be used to distinguish force events from thermal irregularity. For example, when the difference between the in-cell measurement and the on-cell measurement exceeds a difference threshold, a force event can be ignored to avoid a false positive force event.

As discussed above with respect to FIG. 3E, the sequence of phases is merely representative and the various operations can be performed in a different order. Additionally, one or more of the various phases can be divided into sub-phases.

FIG. 6 illustrates an exemplary process for sensing force at a touch screen according to example of the disclosure. Process 500 can be performed by a touch screen, such as touch screen 300, 400, 401, 403 or 500, described above, for example. In some examples, the touch screen can sense a touch using mutual and/or self capacitance measurements (step 602 of process 600). The touch screen can select force sensors for sensing a force (step 604 of process 600). In some examples, the touch screen can select sensors that are in one or more regions for which a touch was measured in step 602. Additionally or alternatively, in some examples, force sensors can be selected independently from the touch measurement by selecting all force sensors, or a predetermined subset of force sensors, for example. In some examples, the touch screen can measure force using one or more force sensors (step 606 of process 600). In some examples, measuring force can include using in-cell force sensors as described with reference to FIGS. 3A-3E, using on-cell force sensors as described with reference to FIGS. 4A-4E, or using both types of force sensors as described with reference to FIGS. 5A-5B. Sensing a force can further include compensating for thermal irregularities and other sources of noise, for example. In some examples, an action can be performed in response to the measured touch and measured force (step 608 of process 600). For example, the actions can include previewing the content of a user interface element on which the force has been provided, providing shortcuts into a user interface element on which the force has been provided, or the like.

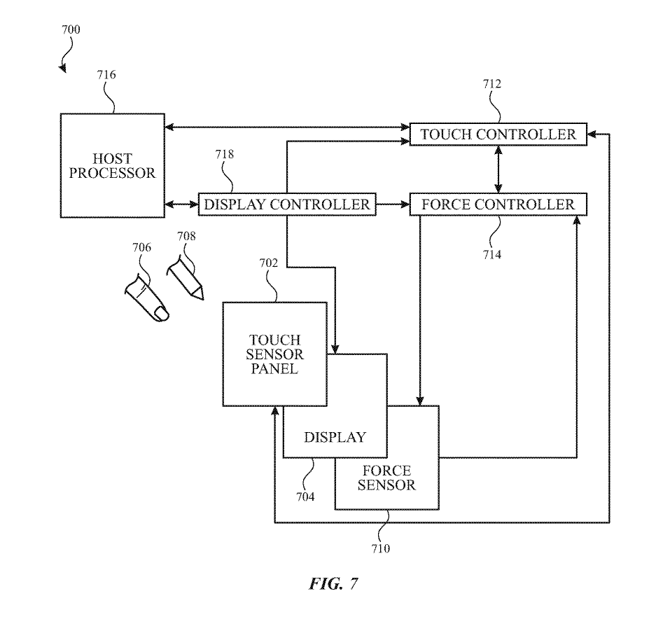

FIG. 7 illustrates exemplary computing system 700 capable of implementing force sensing according to examples of the disclosure. Computing system 700 can include a touch sensor panel 702 to detect touch or proximity (e.g., hover) events from a finger 706 or stylus 708 at a device, such as a mobile phone, tablet, touchpad, portable or desktop computer, portable media player, wearable device or the like. Touch sensor panel 702 can include a pattern of electrodes to implement various touch and/or stylus sensing scans. The pattern of electrodes can be formed of a transparent conductive medium such as Indium Tin Oxide (ITO) or Antimony Tin Oxide (ATO), although other transparent and non-transparent materials, such as copper, can also be used. For example, the touch sensor panel 702 can include an array of touch nodes that can be formed by a two-layer electrode structure (e.g., row and column electrodes) separated by a dielectric material, although in other examples the electrodes can be formed on the same layer. Touch sensor panel 702 can be based on self-capacitance or mutual capacitance or both, as previously described.

In addition to touch sensor panel 702, computing system 700 can include display 704 and force sensor circuitry 710 (e.g., including force-sensing metallization traces 302, 402, 503, and/or 504) to create a touch- and force-sensitive display screen. Display 704 can use liquid crystal display (LCD) technology, light emitting polymer display (LPD) technology, organic LED (OLED) technology, or organic electro luminescence (OEL) technology, although other display technologies can be used in other examples. In some examples, the touch sensor panel 702, display 704 and/or force sensor circuitry 710 can be stacked on top of one another. For example, touch sensor panel 702 can cover a portion or substantially all of a surface of display 704. In other examples, the touch sensor panel 702, display 704 and/or force sensor circuitry 710 can be partially or wholly integrated with one another (e.g., share electronic components, such as in an in-cell touch screen).

Computing system 700 can include one or more processors, which can execute software or firmware implementing and synchronizing display functions and various touch, stylus and/or force sensing functions according to examples of the disclosure. The one or more processors can include a touch processor in touch controller 712, a force processor in force controller 714 and a host processor 716. Force controller 714 can implement force sensing operations, for example, by controlling force sensor circuitry 710 and receiving force sensing data (e.g., a voltage of a force sensor) from the force sensor circuitry 710 (e.g., from one or more electrodes mounted on a flex circuit). In some examples, the force controller 714 can implement the force sensing, error metric tracking and/or coefficient learning processes of the disclosure. In some examples, the force controller 714 can be coupled to the touch controller 712 (e.g., via an I2C bus) such that the touch controller can configure the force controller 714 and receive the force information from the force controller 714. The force controller 714 can include the force processor and can also include other peripherals (not shown) such as random access memory (RAM) or other types of memory or storage. In some examples, the force controller 714 can be implemented as a single application specific integrated circuit (ASIC) including the force processor and peripherals, though in other examples, the force controller can be divided into separate circuits.

Touch controller 712 can include the touch processor and can also include peripherals (not shown) such as random access memory (RAM) or other types of memory or storage, watchdog timers and the like. Additionally, touch controller 712 can include circuitry to drive (e.g., analog or digital scan logic) and sense (e.g., sense channels) the touch sensor panel 702, which in some examples can be configurable based on the scan event to be executed (e.g., mutual capacitance row-column scan, row self-capacitance scan, stylus scan, pixelated self-capacitance scan, etc.). The touch controller 712 can also include one or more scan plans (e.g., stored in memory) that can define a sequence of scan events to be performed at the touch sensor panel 702. In one example, during a mutual capacitance scan, drive circuitry can be coupled to each of the drive lines on the touch sensor panel 702 to stimulate the drive lines, and the sense circuitry can be coupled to each of the sense lines on the touch sensor panel to detect changes in capacitance at the touch nodes. The drive circuitry can be configured to generate stimulation signals to stimulate the touch sensor panel one drive line at a time, or to generate multiple stimulation signals at various frequencies, amplitudes and/or phases that can be simultaneously applied to drive lines of touch sensor panel 702 (i.e., multi-stimulation scanning). In some examples, the touch controller 712 can be implemented as a single application specific integrated circuit (ASIC) including the touch processor, drive and sense circuitry, and peripherals, though in other examples, the touch controller can be divided into separate circuits. The touch controller 712 can also include a spectral analyzer to determine low noise frequencies for touch and stylus scanning. The spectral analyzer can perform spectral analysis on the scan results from an unstimulated touch sensor panel 702.

Host processor 716 can receive outputs (e.g., touch information) from touch controller 712 and can perform actions based on the outputs that can include, but are not limited to, moving one or more objects such as a cursor or pointer, scrolling or panning, adjusting control settings, opening a file or a document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, or the like. Host processor 716 can receive outputs (e.g., force information) from force controller 714 and can perform actions based on the outputs that can include previewing the content of a user interface element on which the force has been provided, providing shortcuts into a user interface element on which the force has been provided, or the like. Host processor 716 can execute software or firmware implementing and synchronizing display functions and various touch, stylus and/or force sensing functions. Host processor 716 can also perform additional functions that may not be related to touch sensor panel processing, and can be coupled to program storage and display 704 for providing a user interface (UI) to a user of the device. Display 704 together with touch sensor panel 702, when located partially or entirely under the touch sensor panel 702, can form a touch screen. The computing system 700 can process the outputs from the touch sensor panel 702 to perform actions based on detected touch or hover events and the displayed graphical user interface on the touch screen.

Computing system 700 can also include a display controller 718. The display controller 718 can include hardware to process one or more still images and/or one or more video sequences for display on display 704. The display controller 718 can be configured to generate read memory operations to read the data representing the frame/video sequence from a memory (not shown) through a memory controller (not shown), for example. The display controller 718 can be configured to perform various processing on the image data (e.g., still images, video sequences, etc.). In some examples, the display controller 718 can be configured to scale still images and to dither, scale and/or perform color space conversion on the frames of a video sequence. The display controller 718 can be configured to blend the still image frames and the video sequence frames to produce output frames for display. The display controller 718 can also be more generally referred to as a display pipe, display control unit, or display pipeline. The display control unit can be generally any hardware and/or firmware configured to prepare a frame for display from one or more sources (e.g., still images and/or video sequences). More particularly, the display controller 718 can be configured to retrieve source frames from one or more source buffers stored in memory, composite frames from the source buffers, and display the resulting frames on the display 704. Accordingly, display controller 718 can be configured to read one or more source buffers and composite the image data to generate the output frame.

In some examples, the display controller and host processor can be integrated into an ASIC, though in other examples, the host processor 716 and display controller 718 can be separate circuits coupled together. The display controller 718 can provide various control and data signals to the display, including timing signals (e.g., one or more clock signals) and/or vertical blanking period and horizontal blanking interval controls. The timing signals can include a display pixel clock that can indicate transmission of a display pixel. The data signals can include color signals (e.g., red, green, blue). The display controller 718 can control the display 704 in real-time, providing the data indicating the display pixels to display the image indicated by the frame. The interface to such a display 704 can be, for example, a video graphics array (VGA) interface, a high definition multimedia interface (HDMI), a digital video interface (DVI), a LCD interface, a plasma interface, or any other suitable interface.

Note that one or more of the functions described above can be performed by firmware stored in memory and executed by the touch processor in touch controller 712, or stored in program storage and executed by host processor 716. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium (excluding a signal) that can contain or store the program for use by or in connection with the instruction execution system, apparatus, or device. The non-transitory computer readable medium storage can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

It is to be understood that the computing system 700 is not limited to the components and configuration of FIG. 7, but can include other or additional components in multiple configurations according to various examples. Additionally, the components of computing system 700 can be included within a single device, or can be distributed between multiple devices.

Therefore, according to the above, some examples of the disclosure are related to an electronic device comprising: a metallization layer including one or more spiral-shaped metallization traces; a conductive layer electrically coupled to the metallization layer; and an insulator disposed between one or more portions of the metallization layer and one or more portions of the conductive layer. Additionally or alternatively, in some examples. The electronic device of claim 1, further comprising a force controller configured to: apply a first signal to an electrode of the conductive layer; sense one or more second signals at a metallization trace of the one or more spiral-shaped metallization traces, the one or more second signals indicative of a force applied to a surface of the electronic device. Additionally or alternatively, in some examples, the first signal comprises a current and the one or more second signals comprise a voltage. Additionally or alternatively, in some examples, the electronic device can further comprise one or more touch electrodes operatively coupled to a touch controller configured to determine a location of one or more proximate objects at a surface of the electronic device, wherein: the touch controller is operatively coupled to the force controller, and the force controller is further configured to select one or more metallization traces to sense based on the determined location of the one or more proximate objects. Additionally or alternatively, in some examples, the electronic device can further comprise a plurality of display pixels configured to display an image, wherein the electronic device concurrently displays the image and measures the force. Additionally or alternatively, in some examples, the force controller is further configured to determine one or more of a location of the force and a magnitude of the force based on the one or more second signals. Additionally or alternatively, in some examples, the metallization layer including one or more spiral-shaped metallization traces is a third metallization layer, and the electronic device further comprises: a first metallization layer; and a second metallization layer. Additionally or alternatively, in some examples, the electronic device further comprises one or more touch electrodes operatively coupled to a touch controller configured to determine a location of one or more proximate objects at a surface of the electronic device. Additionally or alternatively, in some examples, the electronic device further comprises a color filter layer and a thin film transistor (TFT) layer, wherein the metallization layer, conductive layer, and insulator are disposed between the color filter layer and the TFT layer.

Some examples of the disclosure are related to an electronic device comprising: a metallization layer including one or more spiral-shaped metallization traces; a conductive layer electrically coupled to the metallization layer; an insulator disposed between one or more portions of the metallization layer and one or more portions of the conductive layer; a color filter layer disposed above the metallization layer, the conductive layer, and the insulator; and a thin film transistor (TFT) layer disposed below the metallization layer, the conductive layer, and the insulator. Additionally or alternatively, in some examples, the electronic device can further comprise a force controller configured to: apply a first signal to a conductor of the conductive layer; and sense one or more second signals at a metallization trace of the one or more spiral-shaped metallization traces, the second signal indicative of an applied force at a surface of the electronic device. Additionally or alternatively, in some examples, the first signal comprises a current and the one or more second signals comprise a voltage. Additionally or alternatively, in some examples, the force controller is further configured to select the conductor and the metallization trace based on a location of one or more proximate objects at the surface of the device. Additionally or alternatively, in some examples, the force controller is further configured to determine one or more of a location and a magnitude of the applied force based on the second signal. Additionally or alternatively, in some examples, the electronic device can further comprise a display controller configured to: couple a metallization trace of the one or more spiral-shaped metallization traces and a conductor of the conductive layer to a common voltage to display an image on the device. Additionally or alternatively, in some examples, the electronic device can further comprise a touch controller configured to: sense a self-capacitance of a metallization trace of the one or more spiral-shaped metallization traces and a conductor of the conductive layer, the self-capacitance indicative of one or more proximate objects at a surface of the device. Additionally or alternatively, in some examples, the metallization layer including one or more spiral-shaped metallization traces is a third metallization layer, and the electronic device further comprises: a first metallization layer; and a second metallization layer.

Some examples of the disclosure are related to an electronic device comprising: a first metallization layer including one or more spiral-shaped first metallization traces; a first conductive layer electrically coupled to the first metallization layer; a first insulator disposed between one or more portions of the first metallization layer and one or more portions of the first conductive layer; a second metallization layer including one or more spiral-shaped second metallization traces; a second conductive layer electrically coupled to the second metallization layer; and a second insulator in direct contact with one or more portions of the second metallization layer and one or more portions of the second conductive layer. Additionally or alternatively, in some examples, the electronic device can further comprise a force controller configured to: apply a first signal to a first conductor of the first conductive layer; sense one or more second signals at a first metallization trace of the first metallization traces; apply a third signal to a second conductor of the second conductive layer; and sense one or more fourth signals at a second metallization trace of the second metallization traces. Additionally or alternatively, in some examples, the first conductor, first metallization, second conductor, and second metallization are disposed at respective locations on respective layers, the respective locations corresponding to a same location at a surface of the electronic device, and the force controller is further configured to: compare a difference between the one or more second signals and the one or more fourth signals to a difference threshold; based on a determination that the difference is below the difference threshold, determine that the one or more second signals and the one or more fourth signals are indicative of an applied force; and based on a determination that the difference is above the difference threshold, discard the one or more of the one or more second signals and the one or more fourth signals. Additionally or alternatively, in some examples, the force controller is further configured to select the first conductor, the first metallization, the second conductor, and the second metallization at which to sense force based on a location of one or more proximate objects at a surface of the electronic device. Additionally or alternatively, in some examples, the first and third signals comprise currents and the second and fourth signals comprise voltages. Additionally or alternatively, in some examples, the electronic device further can further comprise a display controller configured to: during a display phase, couple a metallization trace of the one or more spiral-shaped first metallization traces and a conductor of the first conductive layer to a common voltage to display an image on the device. Additionally or alternatively, in some examples, the electronic device can further comprise a touch controller configured to: during a touch phase, sense a self-capacitance of a metallization trace of the one or more spiral-shaped first metallization traces and a conductor of the first conductive layer, the self-capacitance indicative of one or more proximate objects at a surface of the device. Additionally or alternatively, in some examples, the first metallization layer and the first conductive layer are disposed between a color filter of the device and a first surface of a thin film transistor (TFT) layer of the device, and the second metallization layer and the second conductive layer are disposed adjacent to a second side of the TFT layer, the second side of the TFT layer opposite the first side of the TFT layer. Additionally or alternatively, in some examples, the electronic device can further comprise a third metallization layer; and a fourth metallization layer.

Some examples of the disclosure are related to a method of sensing an applied force at a surface of an electronic device, the method comprising applying a first signal to a conductor of a conductive layer of the device; and sensing a second signal of a spiral-shaped metallization trace of a metallization layer of the device, the metallization layer electrically coupled to the conductive layer and the second signal indicative of the applied force. Additionally or alternatively, in some examples, the method can further comprise sensing, at one or more touch nodes of the device, one or more proximate objects at the surface of the device; and selecting the conductor and the spiral-shaped metallization based on a determined location of the one or more proximate objects at the surface of the device. Additionally or alternatively, in some examples, the touch is sensed at a first time and the force is sensed at a second time different from the first time. Additionally or alternatively, in some examples, the second time follows the first time. Additionally or alternatively, in some examples, the first signal is a current and the second signal is a voltage. Additionally or alternatively, in some examples, the method can further comprise performing an action based on the applied force. Additionally or alternatively, in some examples, the method can further comprise displaying, using a display pixel of the electronic device, an image, wherein the image is displayed and the force is sensed at a same time.

Some examples of the disclosure are related to a method of sensing an applied force at a surface of an electronic device, the method comprising: during a display phase, coupling a metallization trace of a metallization layer of the electronic device and a conductor of a conductive layer of the electronic device to a common voltage; during a touch phase, coupling the metallization trace and the conductor of the conductive layer to a touch controller; and during a force phase: coupling the metallization trace and the conductor of the to a force controller; applying a first signal to the conductor; and sense a second signal at the metallization trace, the second signal indicative of an applied force at a surface of the electronic device. Additionally or alternatively, in some examples, the method can further comprise, during the touch phase, sensing a self-capacitance of the metallization trace and the conductor. Additionally or alternatively, in some examples, the method can further comprise, during the touch phase, determining a location of one or more proximate objects at the surface of the electronic device; and during the force phase, selecting the metallization trace and the conductor based on the determined location of the one or more proximate objects at the surface of the electronic device. Additionally or alternatively, in some examples, the first signal comprises a current and the second signal comprises a voltage. Additionally or alternatively, in some examples, the force controller is further configured to determine one or more of a location and a magnitude of the applied force.

Some examples of the disclosure are related to a method of sensing an applied force at a surface of an electronic device, the method comprising: applying a first signal to a first conductor of a first conductive layer of the device; sensing a second signal of a spiral-shaped second metallization trace of a second metallization layer of the device; applying a third signal to a second conductor of a second conductive layer of the device; and sensing a fourth signal of a spiral-shaped second metallization trace of a second metallization layer of the device. Additionally or alternatively, in some examples, the method can further comprise comparing a difference between the second signal and the fourth signal to a difference threshold, wherein the difference is an absolute value; based on a determination that the difference is below the difference threshold, determining that the second and fourth signals are indicative of an applied force; and based on a determination that the difference is above the difference threshold, discarding the one or more of the second and fourth signals. Additionally or alternatively, in some examples, the method can further comprise selecting the first conductor, the first metallization, the second conductor, and the second metallization based on a location of one or more proximate objects at a surface of the electronic device. Additionally or alternatively, in some examples, the first and third signals comprise currents and the second and fourth signals comprise voltages. Additionally or alternatively, in some examples, the method can further comprise, during a display phase, coupling the first metallization trace and the first conductor of the first conductive layer to a common voltage to display an image on the device. Additionally or alternatively, in some examples, the method can further comprise, during a touch phase, sensing a self-capacitance of the first metallization trace and the first conductor, the self-capacitance indicative of one or more proximate objects at a surface of the device.

Some examples of the disclosure are directed to an electronic device comprising a metallization layer including one or more metallization traces; a conductive layer electrically coupled to the metallization layer; and a force controller operatively coupled to the metallization layer and the conductive layer, the force controller configured to apply a first signal to an electrode of the conductive layer; sense a second signal at a metallization trace; and determine, based on the second signal, an amount of force applied to a surface of the electronic device.

Some examples of the disclosure are directed to an electronic device comprising: a metallization layer; a conductive layer electrically coupled to the metallization layer; and one or more processors configured to: during a display phase, couple a metallization trace of the metallization layer and a conductor of the conductive layer to a common voltage; during a touch phase, couple the metallization trace of the metallization layer and the conductor of the conductive layer to a touch controller; and during a force phase, couple the metallization trace of the metallization layer and the conductor of the conductive layer to a force controller, apply a first signal to the conductor of the conductive layer and sense a second signal at the metallization trace of the metallization layer, the second signal indicative of an applied force at a surface of the electronic device.

Some examples of the disclosure are directed to an electronic device comprising: a first metallization trace of a metallization layer electrically coupled to a first conductor of a conductive layer; a second metallization trace of the metallization layer electrically coupled to a second conductor of the conductive layer; and one or more processors configured to: during a display phase, couple the first metallization trace and the first conductor to a common voltage; during a touch phase, couple the first metallization trace and the first conductor to a touch controller; and during a force phase: couple the first metallization trace and the first conductor to a force controller, apply a first signal to the first conductor, sense a second signal at the first metallization trace and determine a first amount of force at a location on a surface of the electronic device; and couple the second metallization trace and the second conductor to the force controller, apply a third signal to the second conductor, sense a fourth signal at the second metallization traces and determine a second amount of force at the location on the surface of the electronic device; and determine an amount of force at the location on the surface of the electronic device based on the first amount of force and the second amount of force.

Some examples of the disclosure are directed to an electronic device comprising: a metallization layer including one or more spiral-shaped metallization traces; a conductive layer electrically coupled to the metallization layer; and an insulator disposed between one or more portions of the metallization layer and one or more portions of the conductive layer. Additionally or alternatively, in some examples the electronic device further comprises a force controller configured to: apply a first signal to a conductor of the conductive layer; sense one or more second signals at a metallization trace of the one or more spiral-shaped metallization traces, the one or more second signals indicative of a force applied to a surface of the electronic device. Additionally or alternatively, in some examples the electronic device further comprises a plurality of display pixels configured to display an image, wherein the electronic device is configured to concurrently display the image and measure the force. Additionally or alternatively, in some examples the force controller is further configured to determine a location of the force and a magnitude of the force based on the one or more second signals. Additionally or alternatively, in some examples the metallization layer including one or more spiral-shaped metallization traces is a third metallization layer, and the electronic device further comprises: a first metallization layer including electrical connections between a plurality of touch electrodes included in the electronic device; and a second metallization layer including one or more data lines coupled to the plurality touch electrodes, the data lines configured to transmit one or more data signals to the touch electrodes. Additionally or alternatively, in some examples the electronic device further comprises a color filter layer and a thin film transistor (TFT) layer, wherein the metallization layer, conductive layer, and insulator are disposed between the color filter layer and the TFT layer. Additionally or alternatively, in some examples the electronic device further comprises a display controller configured to: couple a metallization trace of the one or more spiral-shaped metallization traces and a conductor of the conductive layer to a common voltage to display an image on the device while concurrently measuring force.

Some examples of the disclosure are directed to an electronic device comprising: a first metallization layer including one or more first spiral-shaped metallization traces; a first conductive layer electrically coupled to the first metallization layer; a first insulator disposed between one or more portions of the first metallization layer and one or more portions of the first conductive layer; a second metallization layer including one or more second spiral-shaped metallization traces; a second conductive layer electrically coupled to the second metallization layer; and a second insulator disposed between one or more portions of the second metallization layer and one or more portions of the second conductive layer. Additionally or alternatively, in some examples the electronic device further comprises a force controller configured to: apply a first signal to a first conductor of the first conductive layer; sense one or more second signals at a first metallization trace of the first spiral-shaped metallization traces; apply a third signal to a second conductor of the second conductive layer; and sense one or more fourth signals at a second metallization trace of the second spiral-shaped metallization traces. Additionally or alternatively, in some examples the first conductor, first metallization trace, second conductor, and second spiral-shaped metallization trace are disposed on respective layers at x-y locations corresponding to an x-y locations at a surface of the electronic device, and the force controller is further configured to: compare a difference between the one or more second signals and the one or more fourth signals to a difference threshold; based on a determination that the difference is below the difference threshold, determine that the one or more second signals and the one or more fourth signals are indicative of an applied force; and based on a determination that the difference is above the difference threshold, discard the one or more of the one or more second signals and the one or more fourth signals. Additionally or alternatively, in some examples the electronic device further comprises a display controller configured to: during a display phase, couple a metallization trace of the one or more spiral-shaped first metallization traces and a conductor of the first conductive layer to a common voltage to display an image on the device. Additionally or alternatively, in some examples the electronic device further comprises a touch controller configured to: during a touch phase, sense a self-capacitance of a metallization trace of the one or more spiral-shaped first metallization traces and a conductor of the first conductive layer, the self-capacitance indicative of one or more objects proximate to a surface of the device. Additionally or alternatively, in some examples the first metallization layer and the first conductive layer are disposed between a color filter of the device and a first surface of a thin film transistor (TFT) layer of the device; and the second metallization layer and the second conductive layer are disposed adjacent to a second side of the TFT layer, the second side of the TFT layer opposite the first side of the TFT layer.

Some examples of the disclosure are related to a method of sensing an applied force at a surface of an electronic device, the method comprising: applying a first signal to a conductor of a conductive layer of the device; and sensing a second signal of a spiral-shaped metallization trace of a metallization layer of the device, the metallization layer electrically coupled to the conductive layer and the second signal indicative of the applied force. Additionally or alternatively, in some examples the method further comprises, during a display phase, coupling the spiral-shaped metallization trace and the conductor to a common voltage; and during a touch phase, coupling the spiral-shaped metallization trace and the conductor of the conductive layer to a touch controller; and during a force phase: coupling the spiral-shaped metallization trace and the conductor to a force controller, wherein the applying the first signal to the conductor and the sensing the second signal of the spiral-shaped metallization trace occur during the force phase. Additionally or alternatively, in some examples the display phase and the force phase occur fully or partially simultaneously. Additionally or alternatively, in some examples the force controller is further configured to determine a location of the applied force and a magnitude of the applied force. Additionally or alternatively, in some examples the conductor of the conductive layer is a first conductor of a first conductive layer of the device, the spiral-shaped metallization trace of the metallization layer is a first spiral-shaped metallization trace of a first metallization layer, and the method further comprises: applying a third signal to a second conductor of a second conductive layer of the device; and sensing a fourth signal of a second spiral-shaped metallization trace of a second metallization layer of the device. Additionally or alternatively, in some examples the method further comprises comparing an absolute difference between the second signal and the fourth signal to an absolute difference threshold; based on a determination that the difference is below the absolute difference threshold, determining that the second and fourth signals are indicative of an applied force; and based on a determination that the difference is above the absolute difference threshold, discarding the one or more of the second and fourth signals. Additionally or alternatively, in some examples the method further comprises selecting the first conductor, the first metallization, the second conductor, and the second metallization based on a location of one or more objects proximate to a surface of the electronic device.

In some examples, one or more of the methods described above can be stored on a non-transitory computer-readable medium to be read and executed by one or more processors.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed:

1. An electronic device comprising:
a metallization layer including one or more spiral-shaped metallization traces;
a conductive layer electrically coupled to the metallization layer; and
an insulator disposed between one or more portions of the metallization layer and one or more portions of the conductive layer.

2. The electronic device of claim 1, further comprising a force controller configured to:
apply a first signal to a conductor of the conductive layer;
sense one or more second signals at a metallization trace of the one or more spiral-shaped metallization traces, the one or more second signals indicative of a force applied to a surface of the electronic device.

3. The electronic device of claim 2, further comprising a plurality of display pixels configured to display an image, wherein the electronic device is configured to concurrently display the image and measure the force.

4. The electronic device of claim 2, wherein the force controller is further configured to determine a location of the force and a magnitude of the force based on the one or more second signals.

5. The electronic device of claim 1, wherein the metallization layer including one or more spiral-shaped metallization traces is a third metallization layer, and the electronic device further comprises:
a first metallization layer including electrical connections between a plurality of touch electrodes included in the electronic device; and
a second metallization layer including one or more data lines coupled to the plurality touch electrodes, the data lines configured to transmit one or more data signals to the touch electrodes.

6. The electronic device of claim 1, further comprising a color filter layer and a thin film transistor (TFT) layer, wherein the metallization layer, conductive layer, and insulator are disposed between the color filter layer and the TFT layer.

7. The electronic device of claim 1, further comprising a display controller configured to:
couple a metallization trace of the one or more spiral-shaped metallization traces and a conductor of the conductive layer to a common voltage to display an image on the device while concurrently measuring force.

8. An electronic device comprising:
a first metallization layer including one or more first spiral-shaped metallization traces;
a first conductive layer electrically coupled to the first metallization layer;
a first insulator disposed between one or more portions of the first metallization layer and one or more portions of the first conductive layer;
a second metallization layer including one or more second spiral-shaped metallization traces;
a second conductive layer electrically coupled to the second metallization layer; and
a second insulator disposed between one or more portions of the second metallization layer and one or more portions of the second conductive layer.

9. The electronic device of claim 8, further comprising a force controller configured to:
apply a first signal to a first conductor of the first conductive layer;
sense one or more second signals at a first metallization trace of the first spiral-shaped metallization traces;
apply a third signal to a second conductor of the second conductive layer; and
sense one or more fourth signals at a second metallization trace of the second spiral-shaped metallization traces.

10. The electronic device of claim 9 wherein the first conductor, first metallization trace, second conductor, and second spiral-shaped metallization trace are disposed on respective layers at x-y locations corresponding to an x-y locations at a surface of the electronic device, and the force controller is further configured to:
compare a difference between the one or more second signals and the one or more fourth signals to a difference threshold;
based on a determination that the difference is below the difference threshold, determine that the one or more second signals and the one or more fourth signals are indicative of an applied force; and
based on a determination that the difference is above the difference threshold, discard the one or more of the one or more second signals and the one or more fourth signals.

11. The electronic device of claim 8, further comprising a display controller configured to:
during a display phase, couple a metallization trace of the one or more spiral-shaped first metallization traces and a conductor of the first conductive layer to a common voltage to display an image on the device.

12. The electronic device of claim 8, further comprising a touch controller configured to:
during a touch phase, sense a self-capacitance of a metallization trace of the one or more spiral-shaped first metallization traces and a conductor of the first conductive layer, the self-capacitance indicative of one or more objects proximate to a surface of the device.

13. The electronic device of claim 8, wherein:
the first metallization layer and the first conductive layer are disposed between a color filter of the device and a first surface of a thin film transistor (TFT) layer of the device; and
the second metallization layer and the second conductive layer are disposed adjacent to a second side of the TFT layer, the second side of the TFT layer opposite the first side of the TFT layer.

14. A method of sensing an applied force at a surface of an electronic device, the method comprising:
applying a first signal to a conductor of a conductive layer of the device; and
sensing a second signal of a spiral-shaped metallization trace of a metallization layer of the device, the metallization layer electrically coupled to the conductive layer and the second signal indicative of the applied force.

15. The method of claim 14, further comprising:
during a display phase, coupling the spiral-shaped metallization trace and the conductor to a common voltage; and
during a touch phase, coupling the spiral-shaped metallization trace and the conductor of the conductive layer to a touch controller; and
during a force phase:
coupling the spiral-shaped metallization trace and the conductor to a force controller, wherein the applying the first signal to the conductor and the sensing the second signal of the spiral-shaped metallization trace occur during the force phase.

16. The method of claim 15, wherein the display phase and the force phase occur fully or partially simultaneously.

17. The method of claim 14, wherein the force controller is further configured to determine a location of the applied force and a magnitude of the applied force.

18. The method of claim 14, wherein:
the conductor of the conductive layer is a first conductor of a first conductive layer of the device,
the spiral-shaped metallization trace of the metallization layer is a first spiral-shaped metallization trace of a first metallization layer, and the method further comprises:
applying a third signal to a second conductor of a second conductive layer of the device; and
sensing a fourth signal of a second spiral-shaped metallization trace of a second metallization layer of the device.

19. The method of claim 18, further comprising:
comparing an absolute difference between the second signal and the fourth signal to an absolute difference threshold;
based on a determination that the difference is below the absolute difference threshold, determining that the second and fourth signals are indicative of an applied force; and
based on a determination that the difference is above the absolute difference threshold, discarding the one or more of the second and fourth signals.

20. The method of claim 18, further comprising:
selecting the first conductor, the first metallization, the second conductor, and the second metallization based on a location of one or more objects proximate to a surface of the electronic device.
